(19) United States
(12) Patent Application Publication
(10) Pub. No.: US 2017/0241211 A1
(43) Pub. Date: Aug. 24, 2017

(54) CONTINUOUS CARBON FIBER SUCKER ROD AND METHOD OF MANUFACTURE

(71) Applicant: Lifting Solutions USA, Inc., Irvine, CA (US)

(72) Inventor: Rob Sjostedt, Foothill Ranch, CA (US)

(21) Appl. No.: 15/436,122

(22) Filed: Feb. 17, 2017

Related U.S. Application Data
(60) Provisional application No. 62/297,470, filed on Feb. 19, 2016.

(51) Int. Cl. E21B 17/00; B29C 47/02; B29C 70/52

(52) U.S. Cl. CPC E21B 17/00; B29C 70/52; B29C 47/025; E21B 43/126

(57) ABSTRACT

A continuous length composite sucker rod assembly is provided for use in down-hole wells. The assembly can include a plurality of parallel composite strands forming an elongate rod. The strands can be encapsulated with a thermoplastic polymer by co-extrusion. A terminus can be affixed to both ends of the length of sucker rod by splaying the strands out into a conical cavity within the terminus and casting a polymer wedge plug. The resulting sucker rod assembly can be readily coiled in a transportable diameter by virtue of the composite strands being able to twist when the rod is coiled and untwist when the rod is un-coiled.

### CROSS-REFERENCE TO RELATED APPLICATIONS

This application claims priority of co-pending U.S. Provisional Patent Application Ser. No. 62/297,470 filed Feb. 19, 2016, which is incorporated by reference herein in its entirety.

### TECHNICAL FIELD

The present disclosure is related to the field of sucker rod engineering and design, in particular, composite sucker rod assemblies for use in down-hole vertical lift oil extraction.

### BACKGROUND

Sucker rods for use with vertical lift rod pumps, actuated by surface units (also referred to as surface units, rocking horse or pump jacks), are traditionally made from individual lengths of steel rod sections that are connected together by threaded couplings. The individual sucker rods are typically 25 feet, 30 feet or 37.5 feet in length and are connected together with couplings to form a sucker rod string. A typical sucker rod string is from 700 to 10,000 feet or more in length. The sucker rod string connects the vertical lift surface device to the down-hole pump unit. The design length of the traditional sucker rod is for service convenience. Work-over derrick rigs are brought into position above the well to pull the string and access the down-hole pump for service. The height of the work-over rig derrick determines the individual segment length of a sucker rod that can be pulled one at a time until the entire sucker rod string is pulled out of the well. The process to incrementally pull each sucker rod in order to access the down-hole pump for service requires noteworthy time, manpower and expense.

Fiberglass sucker rods the same lengths as steel sucker rods have also been used. Carbon fiber sucker rods as described in U.S. Provisional Application No. 62/003,437 and U.S. Provisional Application No. 61/903,194 (both of these applications are incorporated by reference in their entirety into this application) describe light-weight, low-stretch and corrosion resistance properties compared to steel and fiberglass rods.

Continuous steel sucker rod strings in a variety of forms have also been developed. One perceived advantage of continuous steel sucker rods is the elimination of the many threaded coupling joints that can fatigue and break on conventional sucker rod strings. Another advantage of continuous sucker rods is rapid deployment and removal from the well bore. However, continuous steel sucker rod strings are still heavy, subject to stress corrosion cracking and require large specialized spools and techniques to coil the product for transport, installation and service. A continuous carbon fiber sucker rod would be attractive to the user because of its lightweight, high strength, low stretch and corrosion resistance provided it could be reasonably coiled without damage. To be practical, a continuous length of sucker rod must be coiled to a diameter that can be easily transported over highways and narrow roads to deliver it to the well site.

A simple round monolithic pultruded carbon fiber rod could be made in a suitably long length from 1,000 to 10,000 feet for vertical lift oil well applications as a continuous length rod. The challenges to make a practical and effective continuous sucker are associated with the terminations and coiling. A continuous length carbon fiber rod for the application would need to be made in various sizes from ½ inch diameter to ¾ inch diameter to be suitable to be used in the top 60% or more of the sucker rod string. Monolithic pultruded carbon fiber rods in these diameters are very stiff in terms of bending. Considerable stress must be applied to coil such a product and the resultant strain can cause failure in the unidirectional composite due to the low inter-laminar strength associated with these materials. The end result is the coiled diameter must be unreasonably large (hence not easily transported) to manage the stress and strain energy and not cause damage to the carbon fiber rod. One early attempt at a continuous carbon fiber sucker rod utilized a pultruded rectangular strap configuration (approximately 3/16 inch thick by 1 and ¼ inch wide in cross section) that could be coiled in a reasonably small diameter. While convenient to coil, this product did not gain wide acceptance for other reasons primarily the strength of the terminations. Other attempts at a continuous carbon fiber sucker rod have utilized an oval cross section for the pultruded rod such that it can be coiled in a slightly smaller diameter than a round rod. Even an oval cross section suitable for the sucker rod application has considerable strain when coiled at a reasonable diameter that can be damaging to the composite. A secondary related but still important criterion for a continuous carbon fiber sucker rod is the termination required at each end. The termination must be as close to the strength of the mid-span of the rod as possible to be usable. A strong and reliable termination is difficult to make on a monolithic round or oval pultruded carbon fiber rod because the adhesively bonded terminus is only attached to the outer surface of the monolithic cross section rod and not to the individual fibers or strands that make up the carbon fiber rod.

It is, therefore, desirable to provide a continuous carbon fiber sucker rod that overcomes the shortcomings of the prior art.

### SUMMARY

A continuous carbon fiber sucker rod assembly and its method of manufacture are provided.

Broadly stated, in some embodiments, a method can be provided for manufacturing a length of rod, the method comprising: drawing a plurality of pultruded carbon fiber rods through a collector die to organize the plurality of pultruded carbon fiber rods into a predetermined cross-section shape; drawing the plurality of pultruded carbon fiber rods through an extrusion die; and encapsulating the plurality of pultruded carbon fiber rods in a jacket of heated thermoplastic polymer by extruding the heated thermoplastic polymer about the plurality of pultruded carbon fiber rods through the extrusion die.

Broadly stated, in some embodiments, the method can further comprise spooling the encapsulated plurality of pultruded carbon fiber rods.

Broadly stated, in some embodiments, the method can further comprise cooling the encapsulated plurality of rods after exiting the extrusion die.

Broadly stated, in some embodiments, the method can further comprise fitting an end fitting cone onto at least one end of the length of rod, the end fitting cone further comprising a coupling pin.

Broadly stated, in some embodiments, a system can be provided for manufacturing a length of rod, the system comprising: at least one spools for providing a supply of a plurality of pultruded carbon fiber rods; a collector die for organizing the plurality of pultruded carbon fiber rods into a predetermined cross-section shape; an extrusion die configured for encapsulating the organized plurality of pultruded carbon fiber rods with heated thermoplastic polymer to form the length of rod; and a puller unit configured for pulling the encapsulated plurality of pultruded carbon fiber rods from the at least one spool through the collector die and the extrusion die.

Broadly stated, in some embodiments, the system can further comprise a take-up spool for spooling the length of rod.

Broadly stated, in some embodiments, the system can further comprise a cooling trough configured for cooling the length of rod after exiting the extrusion die.

Broadly stated, in some embodiments, the system can further comprise means for fitting an end fitting cone onto at least one end of the length of rod, the end fitting cone further comprising a coupling pin.

Broadly stated, in some embodiments, a length of rod can be manufactured using the method or the system as set forth above.

Broadly stated, in some embodiments, the length of rod can further comprise an end fitting cone fitted onto at least one end of the length of rod, the end fitting cone further comprising a coupling pin.

Broadly stated, in some embodiments, one or more of the pultruded carbon fiber rods can comprise a composition of carbon fiber and epoxy.

Broadly stated, in some embodiments, the composition can further comprise one or more from a group comprising of fiberglass, phenolic resin, vinyl ester resin, polyester resin, benzoxyzene resin and cyanurate ester resin.

Broadly stated, in some embodiments, the thermoplastic polymer can comprise one or more of a group comprising of high density polyethylene, polyetherimide, polyphenylenesulfide and polyetheretherketone.

### BRIEF DESCRIPTION OF THE DRAWINGS

FIG. 1A is a side elevation cross-section view depicting a round carbon fiber sucker rod jacketed by an extruded polymer jacket and comprising 37 each 3.3 mm pultruded fiber rods.

FIG. 1B is a side elevation cross-section view depicting a round carbon fiber sucker rod jacketed by an extruded polymer jacket and comprising 30 each 3.3 mm pultruded fiber rods.

FIG. 1C is a side elevation cross-section view depicting an oval carbon fiber sucker rod jacketed by an extruded polymer jacket and comprising 29 each 3.3 mm pultruded fiber rods.

FIG. 1D is a side elevation cross-section view depicting a polygonal carbon fiber sucker rod jacketed by an extruded polymer jacket and comprising 37 each 3.3 mm pultruded fiber rods.

FIG. 1E is a side elevation cross-section view depicting a polygonal carbon fiber sucker rod jacketed by an extruded polymer tube drawn down onto 37 each 3.3 mm pultruded fiber rods.

FIG. 2 is a side elevation view depicting a system carrying out a continuous extrusion process, comprising strand spools, collector plate, cross head extruder, water chill trough downstream of the hot extrusion die, a caterpillar puller device and take up spool.

FIG. 3 is a side elevation view depicting one embodiment of a terminus end fitting and a short length of rod exiting the end fitting.

### DETAILED DESCRIPTION OF EMBODIMENTS

In some embodiments, a continuous sucker rod assembly can be provided, comprising of a plurality of parallel carbon fiber and epoxy composite strength elements, referred to as “strands” to create a light weight, corrosion and fatigue resistant sucker rod assembly. While carbon fiber/epoxy composite strands are uniquely suited for the sucker rod application, other high strength fibers and matrix resins can be also used in the manner described herein. The individual pultruded strands, in some embodiments, can be 2 to 3 millimeters (“mm”) in cross-section when made from carbon fiber and epoxy resin although smaller and larger diameter strands can be employed depending on the application. The number of strands bundled together can determine the strength and stiffness of the continuous sucker rod. The individual strands can be held together by encapsulating the strands in a thermoplastic polymer, such as High Density Polyethylene (“HDPE”), Polyetherimide (“PEI”), Polyphenylenesulfide (“PPS”), Polyetheretherketone (“PEEK”) or any other suitable thermoplastic polymers for down-hole use, as well known to those skilled in the art.

In some embodiments, a method to encapsulate the bundle of pultruded carbon fiber strands can comprise the steps of running the bundle of strands through a cross-head extruder to form a polymer jacket over and around the bundled strands. By this method, long lengths of bundled rod on the order of 1,000 to 12,000 feet in length can be practically encapsulated to be handle-able and coil-able.

In some embodiments, the function of the thermoplastic encapsulation can be three-fold. First, it can provide a means of holding the bundle of parallel composite strands together. Second, it can allow the composite strands to twist a small amount when the sucker rod is coiled. Third, it can provide a wear-resistant encapsulation of the strength elements when they rub against the inner wall of the oil well tubing as the surface unit moves the rod up and down to actuate the down-hole pump.

When a carbon fiber sucker rod made in this manner is coiled, the bundled high modulus strands, which are parallel when encapsulated, can progressively twist since the thermoplastic encapsulation is an unreinforced and lower modulus material. The amount of twist can be very small at any specific location along the length of the sucker rod. However, the twist over a long length of sucker rod can be significant because it progressively develops as the sucker rod is coiled. The twist can be automatically and naturally removed as the sucker rod is deployed off the spool due to the elastic properties of the encapsulation polymer. This is in contrast to a monolithic pultruded composite rod wherein the outer fibers are put in extreme tension and the inner fibers are put in extreme compression when the rod is coiled and the resin matrix is too stiff to allow twist when coiling. Additionally, there is significant inter-laminar shear stress when a monolithic composite rod is coiled. This results in significant strain energy and potential damage to the composite.

In some embodiments, a carbon fiber rod can be manufactured in the following manner. The carbon fiber/epoxy composite strands can first be pultruded. Carbon fiber and epoxy can be used in some embodiments, but other high-strength fibers such as fiberglass and matrix resins such as phenolic, vinyl ester, polyester resin, benzoxyzene, cyanurate ester, amongst others well known to those skilled in the art, can be used in combination with the fiber to make the strands. In some embodiments, the strands can be pultruded in multiple streams at lengths of 2,000 to 12,000 feet, the length dependent only on the length of the carbon fiber spool and coiled on individual spools after pultrusion. Because of the small size of the individual strands, they can be coiled on conventional cable spools as small as 18 inches in diameter when the rods are in the 2 to 3 mm diameter range.

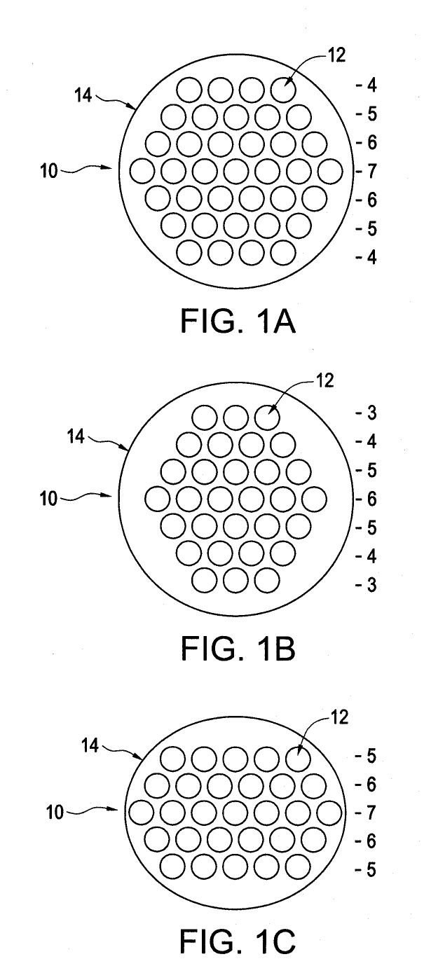

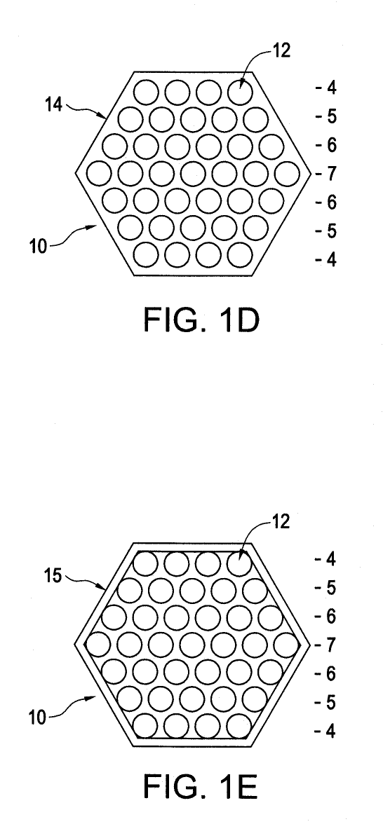

After pultrusion, the strands can be individually unspooled and brought together into a parallel bundle using collector plates. There can be a generally round natural nesting geometry to the bundle since it is made of a plurality of parallel strands that are typically round. For example, a bundle of 37 pultruded rods (12) of 3.3 mm diameter can form sucker rod (10) having a polygon cross-section shape approximately ¾ inches round, as shown in FIG. 1A, wherein pultruded rods (12) can be encapsulated in extruded HDPE jacket (14). Other naturally generally round bundles, meeting the strength and stiffness requirements of typical oil wells, can use 14, 19 or 30 strands of pultruded rods (12) to form sucker rod (10) encapsulated in jacket (14), although other combinations can be used. FIG. 1 B shows a bundle comprising 30 pultruded rods (12) encapsulated in jacket (14) to form sucker rod (10). The bundled configuration can also be tailored to create a generally oval cross section that is more easily coiled. FIG. 1C shows an oval bundle comprising 29 pultruded rods (12) encapsulated in jacket (14) to form sucker rod (10). In some embodiments, sucker rod (10) can be formed as a bundle with a polygonal cross-section shape. As an example, FIG. 1D shows a polygonal bundle comprising 37 pultruded rods (12) encapsulated in jacket (14) to form sucker rod (10). In this example, sucker rod (10) comprises a 6-sided polygonal cross-section shape although it is obvious to those skilled in the art that sucker rod (10) can comprise a polygonal cross-section shape of any number of sides.

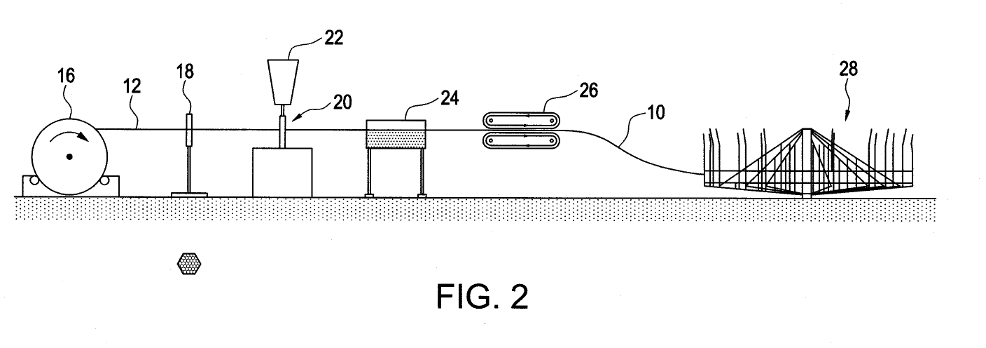

In some embodiments, the composite strands can be run through a cross-head screw extrusion machine die. Referring to FIG. 2, in some embodiments, a plurality of pultruded rods (12) can be drawn from spool (16) (which can include up to 37 separate 4 foot diameter spools, each containing up to 10,000 feet of 3.3 mm diameter pultruded carbon rod), and drawn through die (18). In some embodiments, die (18) can be perfectly round in cross section even though the bundle of strands may be a polygon. Thermoplastic polymers such as HDPE, PEI, PPS or PEEK can be introduced to extrusion die machine (20) in pellet form, which can be stored in pellet hopper (22) for feeding into die machine (20). In some embodiments, extrusion die machine (20) can melt and pressure the thermoplastic pellets into extrusion die machine (20) as rods (12) are pulled by traction unit (26) just downstream of extrusion die machine (20). In some embodiments, extrusion die machine (20) can be configured to form a sucker rod having a round cross-section shape, as shown in FIGS. 1A and 1B. In some embodiments, extrusion die machine (20) can be configured to form a sucker rod having an oval cross-section shape, as shown in FIG. 1C. In some embodiments, die (20) can be configured to form a sucker rod having a polygonal cross-section shape, as shown in FIG. 1D.

In other embodiments, an HDPE tube can be co-extruded and continuously drawn down onto the outside of rods (12) as HDPE tube (15) cools (as well known to those skilled in the art), wherein the drawn down HDPE tube (15) can comprise a “leather-like” outer surface once it has been drawn down onto rods (12) to form sucker rod (10), as shown in FIG. 1E.

In some embodiments, traction unit (26) can comprise a dual caterpillar tractor belt mechanism. In other embodiments, traction unit (26) can comprise reciprocating gripper pullers as used in pultrusion machines. The feed rate of thermoplastic polymer to fully encapsulate the bundle of carbon fiber strands can be proportional to the speed in which the strands are pulled through the extrusion die. Composite strands can be drawn from their respective supply spools as the product is pulled through the collector plates and the extrusion die in a continuous manner. In some embodiments, water chill bath (24) can be placed between hot extrusion die machine (20) and puller system (26) to cool finished sucker rod (10) product exiting die machine (20), to be spooled onto take up spool (28) for transport to a well site.

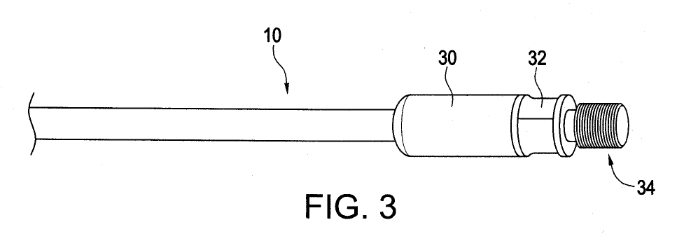

A short length of exposed strands (with no extruded jacket) can be left at the beginning and the end of the continuous length of sucker rod to facilitate affixing the terminus as described in U.S. Provisional Application No. 62/003,437 and U.S. Provisional Application No. 61/903,194, which are incorporated into this application by reference in their entirety. Referring to FIG. 3, as an example, sucker rod (10) can be fitted with end fitting cone (30) using the techniques as described in these applications, wherein cone (30) can further comprise wrench flats (32) and threaded coupling pin (34). Wrench flats (32) enable the use of a wrench to engage flats (32) for threading coupling pin (34) into an adjoining coupler as well known to those skilled in the art (not shown) for coupling to another length of sucker rod (10) (not shown). The resultant product can then be a continuous long length of carbon fiber sucker rod (10) on the order of 1,000 to 12,000 feet in length, or more.

While the assemblies and methods described herein can be used as a continuous composite sucker rod, one skilled in the art will immediately recognize that such assemblies and methods can be used for making any long length of composite cable that needs to be stored in a reasonable diameter without damage due to coiling.

Although a few embodiments have been shown and described, it will be appreciated by those skilled in the art that various changes and modifications can be made to these embodiments without changing or departing from their scope, intent or functionality. The terms and expressions used in the preceding specification have been used herein as terms of description and not of limitation, and there is no intention in the use of such terms and expressions of excluding equivalents of the features shown and described or portions thereof, it being recognized that the invention is defined and limited only by the claims that follow.

We claim:

1. A method for manufacturing a length of rod, the method comprising:
drawing a plurality of pultruded carbon fiber rods through a collector die to organize the plurality of pultruded carbon fiber rods into a predetermined cross-section shape;
drawing the plurality of pultruded carbon fiber rods through an extrusion die; and
encapsulating the plurality of pultruded carbon fiber rods in a jacket of heated thermoplastic polymer by extruding the heated thermoplastic polymer about the plurality of pultruded carbon fiber rods through the extrusion die.

2. The method as set forth in claim 1, further comprising spooling the encapsulated plurality of pultruded carbon fiber rods.

3. The method as set forth in claim 1, further comprising cooling the encapsulated plurality of rods after exiting the extrusion die.

4. The method as set forth in claim 1, further comprising fitting an end fitting cone onto at least one end of the length of rod, the end fitting cone further comprising a coupling pin.

5. The method as set forth in claim 1, wherein one or more of the pultruded carbon fiber rods comprises a composition of carbon fiber and epoxy.

6. The method as set forth in claim 5, wherein the composition further comprises one or more from a group comprising of fiberglass, phenolic resin, vinyl ester resin, polyester resin, benzoxyzene resin and cyanurate ester resin.

7. The method as set forth in claim 1, wherein the thermoplastic polymer comprises one or more of a group comprising of high density polyethylene, polyetherimide, polyphenylenesulfide and polyetheretherketone.

8. A system for manufacturing a length of rod, the system comprising:
at least one spool for providing a supply of a plurality of pultruded carbon fiber rods;
a collector die for organizing the plurality of pultruded carbon fiber rods into a predetermined cross-section shape;
an extrusion die configured for encapsulating the organized plurality of pultruded carbon fiber rods with heated thermoplastic polymer to form the length of rod; and
a puller unit configured for pulling the encapsulated plurality of pultruded carbon fiber rods from the at least one spool through the collector die and the extrusion die.

9. The system as set forth in claim 8, further comprising a take-up spool for spooling the length of rod.

10. The system as set forth in claim 8, further comprising a cooling trough configured for cooling the length of rod after exiting the extrusion die.

11. The system as set forth in claim 8, further comprising means for fitting an end fitting cone onto at least one end of the length of rod, the end fitting cone further comprising a coupling pin.

12. The system as set forth in claim 8, wherein one or more of the pultruded carbon fiber rods comprises a composition of carbon fiber and epoxy.

13. The system as set forth in claim 12, wherein the composition further comprises one or more from a group comprising of fiberglass, phenolic resin, vinyl ester resin, polyester, resin, benzoxyzene resin and cyanurate ester resin.

14. The system as set forth in claim 8, wherein the thermoplastic polymer comprises one or more of a group comprising of high density polyethylene, polyetherimide, polyphenylenesulfide and polyetheretherketone.

15. A length of rod comprising a plurality of pultruded carbon fiber rods encapsulated in thermoplastic polymer, manufactured using a method as set forth in claim 1.

16. A length of rod comprising a plurality of pultruded carbon fiber rods encapsulated in thermoplastic polymer, manufactured using a system as set forth in claim 8.

17. The length of rod as set forth in claim 15, further comprising an end fitting cone fitted onto at least one end of the length of rod, the end fitting cone further comprising a coupling pin.

18. The length of rod as set forth in claim 15, wherein one or more of the pultruded carbon fiber rods comprises a composition of carbon fiber and epoxy.

19. The length of rod as set forth in claim 18, wherein the composition further comprises one or more from a group comprising of fiberglass, phenolic resin, vinyl ester resin, polyester resin, benzoxyzene resin and cyanurate ester resin.

20. The length of rod as set forth in claim 15, wherein the thermoplastic polymer comprises one or more of a group comprising of high density polyethylene, polyetherimide, polyphenylenesulfide and polyetheretherketone.
